(19) United States
(12) Patent Application Publication
(10) Pub. No.: US 2026/0148386 A1
(43) Pub. Date: May 28, 2026

(54) DETECTION OF ABNORMALITY IN SPECIMEN IMAGE

(71) Applicant: Roche Diagnostics Operations, Inc., Indianapolis, IN (US)

(72) Inventor: Nils Bruenggel, Boniswil (CH)

(73) Assignee: Roche Diagnostics Operations, Inc., Indianapolis, IN (US)

(21) Appl. No.: 19/121,993

(22) PCT Filed: Oct. 17, 2023
(86) PCT No.: PCT/EP2023/078869

§ 371 Date: Apr. 17, 2025

(30) Foreign Application Priority Data
Oct. 19, 2022 (EP) 22202584.3

(51) Int. Cl. G06T 7/00; G06V 10/764; G06V 10/82; G06V 20/69

(52) U.S. Cl. CPC G06T 7/0014; G06V 10/764; G06V 10/82; G06V 20/698; G06T 2207/10056; G06T 2207/20036; G06T 2207/20081; G06T 2207/20084; G06T 2207/30024; G06V 2201/03

(57) ABSTRACT

A computer-implemented method of detecting the presence of morphologically abnormal cells in a specimen image comprises: receiving electronic image data representative of a specimen image, the specimen image depicting a plurality of cells; applying an analytical model to each of a plurality of subsets of the image data, each subset corresponding to a respective portion of the specimen image which depicts a single cell, the analytical model configured to output, for each subset of the image data: a value parameterizing a property of the cell; and either a confidence score or an uncertainty score associated with the value, thereby generating output data comprising the plurality of confidence scores or plurality of uncertainty scores; and determining, based on the output data, whether one or more morphologically abnormal cells are likely to be present in the specimen image.

### TECHNICAL FIELD OF THE INVENTION

The present invention relates to a computer-implemented method and associated systems for detecting the presence of morphologically abnormal cells in a specimen image.

### BACKGROUND TO THE INVENTION

In order to train a deep neural network to recognize entities within an image and to accurately identify them, training data (consisting of cell images and type labels) is required to establish a ground truth.

In case of haematology, a specific interest exists to distinguish healthy leukocytes (normal cells) from unhealthy leukocytes (abnormal cells, can be malignant or benign).

While it is possible to collect enough data from common abnormalities (common leukaemia, infections, etc) it is not possible to collect enough data from rare diseases. Rare conditions can lead to significantly different cell appearances, consequently a neural network that has not been trained on these rare appearances cannot make cell classifications with high accuracy.

The proposed invention addresses this issue.

### SUMMARY OF THE INVENTION

At a high-level, the present invention provides a computer-implemented method of detecting the presence of a population of cells having morphological abnormalities by detecting that there are a threshold number of cells in the specimen image which cannot be identified at a predetermined confidence score, or which cannot be identified with below a predetermined uncertainty score. The increased population of cells in a sample which cannot easily be identified is an indicator of the presence of cells having morphological abnormalities. The computer-implemented method provided by the present invention is advantageous since it means that the presence of populations of morphologically abnormal cells can be detected without the need to train an analytical model (e.g. a machine-learning model) on out-of-domain data. The computer-implemented method of the present invention also does not require the need for any modifications to an existing, “vanilla” model.

More specifically, a first aspect of the present invention provides a computer-implemented method of detecting the presence of morphologically abnormal cells in a specimen image, the computer-implemented method comprising: receiving electronic image data representative of a specimen image, the specimen image depicting a plurality of cells; applying an analytical model to each of a plurality of subsets of the image data, each subset corresponding to a respective portion of the specimen image which depicts a single cell, the analytical model configured to output, for each subset of the image data: a value parameterizing a property of the cell; and either a confidence score or an uncertainty score associated with the value, thereby generating output data comprising the plurality of confidence scores or plurality of uncertainty scores; and determining, based on the output data, whether one or more morphologically abnormal cells are likely to be present in the specimen image.

Herein, “likely to be present” may be understood to mean “is present”. In some cases, rather than making an active determination regarding the likelihood of morphologically abnormal cells being present, the computer-implemented method may comprise determining whether a predetermined abnormality criterion is met. When the predetermined abnormality criterion is met, this may be indicative that the presence of morphologically abnormal cells is likely, or that morphologically abnormal cells are present. After either determining whether morphologically abnormal cells are present, or whether the predetermined abnormality criterion is met, the computer-implemented method may further comprise generating an output indicative of the result of the determination. Generating an output may comprise generating instructions which when executed by a display component of a computing device, cause the display component to display a visual indication of the result of the determination. Alternatively, or additionally, the computer-implemented method may comprise transmitting the output to a database accessible by a clinical computer system.

In the event either that it is determined that the abnormality criterion is met, or that the presence of morphologically abnormal cells is likely, the output preferably comprises a flag. The flag may be added to the electronic image data representative of the specimen image. The flag is not necessarily a concrete indication that there are morphologically abnormal cells present in the specimen image, but it flags to a clinician that the specimen image requires further attention.

However, in clinical contexts, rather than making automatic diagnoses, it is desirable, for a wealth of reasons, simply to flag the results to a clinician. The computer-implemented method of the present invention may comprise, in response to a determination that one or more morphologically abnormal cells are likely to be present, generating a flag.

In the context of the present application, the term “value” may refer to a numerical value, but also to a non-numerical value, such as a classification output (on which more later), which may be in the form of a numerical value indicative of a particular classification, or alternatively in the form of a textual output.

Herein, a “morphologically abnormal cell” is a cell whose physical structure differs from a normal cell structure, such that its appearance in a specimen image is different from normal, or “healthy” cells. Many diseases, or other conditions may be detected by the presence of such morphological abnormalities. Thus, the present invention can be used to detect, or to aid in the detection of those conditions which give rise to morphological abnormalities. It should be appreciated, however, that the present invention is unlikely to have an application in detecting conditions which give rise to abnormalities other than morphological abnormalities in cells. The detection of such conditions is outside the scope of this patent application.

In the context of the present invention, a “specimen image” is an image which depicts human or animal tissue. The image may be obtained e.g. from a microscope, or other imaging device. The specimen image is stated to depict a plurality of cells. The specimen image is thus preferably at a magnification which enables the cells to be resolved individually by e.g. an imaging processing algorithm. The specimen image may be an image of a slide of a sample of a bodily fluid or tissue obtained from a human or animal subject. The bodily fluid may be blood, and accordingly, the abnormality may be a haematological abnormality. Blood is not the only bodily fluid for which the computer-implemented method of the present invention may be used to achieve clinically meaningful results. For example, the bodily fluid may include a sample of tissue/organ of a subject, and/or of a product produced by a tissue/organ of a subject. A product produced by a tissue/organ of a subject may e.g. be a product of secretion (e.g. a glandular secretion, milk, colostrum, tears, saliva, sweat, cerumen, mucus), sputum, semen, vaginal/cervical fluid, blood (plasma, serum), cerebrospinal fluid (CSF), a product of excretion, faeces, or urine, skin or hair.

The computer-implemented method of the first aspect of the invention includes the application of an analytical model. Herein, the term “analytical model” may refer to a mathematical model configured to determine at least one target variable for at least one state variable. The term “target variable” may refer to a clinical value which is to be predicted. The target variable value which is to be predicted may depend on the disease or condition whose presence or status is to be predicted. The target variable may be either numerical or categorical. For example, the target variable may be categorical and may be “positive” in case of presence of disease or “negative” in case of absence of the disease. In other cases, the target variable may refer to a classification of a cell type (on which more later). The target variable may be numerical such as at least one value and/or scale value.

The analytical model may be a regression model or a classification model. In the context of the present application, the term “regression model” may be used to refer to an analytical model, the output of which is a numerical value within a range. For example, the output of such a regression model in the present case may be a numerical value. In other cases, the analytical model may be a segmentation model, the output of which is an indication of a segment of the specimen image to which e.g. an individual pixel relates.

In the context of the present application, the term “classification model” may be used to refer to an analytical model, the output of which is a respective classification or score indicative of the type of cell depicted in each subset of image data. For completeness, we note that when the analytical model is a classification model, the “value parameterizing a property of the cell” may be either a numerical or textual output which indicates the type of cell, i.e. the “property” of the cell is the cell type.

Specifically, the analytical model may be a machine-learning model trained to output a respective result indicative of the type of cell which is depicted in a given subset of image data. The machine-learning model may be a regression model or a classification model, as defined previously. The machine-learning model is preferably trained using supervised learning. The machine-learning model may comprise a neural network such as a convolutional neural network.

In preferred implementations, the analytical model is a classification model based on a neural network (such as a convolutional neural network, and/or a deep neural network). In those cases, the classification model has preferably been trained to classify a cell as one of a plurality of cell types, based on data representing an electronic image of that cell. For example, the classification model may be configured to classify a cell as one of a plurality of types of white blood cells, e.g. as at least the following: a neutrophil; a lymphocyte; a monocyte; an eosinophil; and a basophil. The classification model is preferably trained using training data comprising a plurality of images of normal or healthy cells, each image associated with a label indicative of the type of cell. This demonstrates that the classification model (or more generally, the analytical model) does not require training on morphologically abnormal cells.

The analytical model may comprise a plurality of analytical sub-models, each of which may take the form of a machine-learning model as outlined in the previous two paragraphs.

The concept of confidence scores and uncertainty scores are central to the present invention. The terms are well-known in statistics, and indeed in the field of machine-learning. The present invention is applicable in all cases in which the analytical model is able to establish the distribution of normal samples (i.e. healthy, or normal cells). This is because knowledge of the distribution enables an uncertainty score or confidence score to be calculated. Indeed, many analytical models are able calculate an uncertainty or confidence score in addition to the usual output value.

Different analytical models such as machine-learning models report different uncertainties. In computer-implemented methods according to the present invention, of interest is the predictive uncertainty that is caused by the fact that a data point is too far away from the training data to be reliably classified, known as epistemic uncertainty.

In general the uncertainty can be quantified as the amount of disagreement within the predictive distribution reported by the model. The variance or standard deviation are popular ad-hoc choices for this. A theoretically well-founded approach is to define the uncertainty as the mutual information between the model parameters and the output.

The predictive distribution can either be approximated by using an ensemble of models. Use of an ensemble of models may, generally, refer to a process of combining models that were trained to execute the same task (in the present case, classifying images with the same classes). Generally, using ensembles and combining the output of different models is typically done to increase accuracy because non-correlated errors made by the different models cancel out when combining the outputs appropriately. However, the present case, the ensemble may be used in order to obtain a measure of disagreement between the various sub-models in the ensemble, see below. If the ensemble prediction of the individual models in the ensemble disagrees to a large amount this indicates that the data point is further away from the training data, and it therefore should be assigned high epistemic uncertainty. Conversely if the models in the ensemble agree it indicates that the data point is close to the training set and therefore has a low epistemic uncertainty.

More specifically, in the present context, the use of an ensemble may refer to a process in which several analytical sub-models are each used to obtain a respective output. The outputs may then be combined, and the variance or standard deviation (or other information theoretic measure) of the outputs may be used as the uncertainty score. More specifically, applying the analytical model to each of the plurality of subsets of image data may comprise applying a plurality (or ensemble) of analytical sub-models to each subset of the image data. Then, each analytical sub-model of the plurality of analytical sub-models may be configured to output (for each subset of image data) a respective plurality of values each parameterizing a property of the cell. Applying the analytical model to each of the plurality of subsets of image data may further comprise determining, for each output plurality of values, a statistical property indicative of the confidence or uncertainty in the plurality of values. The statistical property may be the variance or the standard deviation, or another information theoretic parameter. Each of the analytical sub-models may be of the same type, and trained on the same training data. In order to ensure that the ensemble of analytical sub-models is not all identical (in which case it would not be possible to obtain a meaningful uncertainty score), it is preferred that each analytical sub-model of the plurality of analytical sub-models differs at least by the initial random seed that is used randomly to initialize the models before training.

In some cases, the various analytical sub-models may not be the same type, e.g. some of the analytical sub-models may be convolutional neural networks, and some may be transformers, and so on. The different types of sub-model may be trained on the same or different training data sets. However, the different types of sub-model are all trained on the same task (i.e. classification into the same classes).

The predictive distribution can also be approximated by other means, for example by using dropout. In the context of machine-learning, the term “dropout” is used to refer to a process in which some number of neurons are randomly ignored (i.e. dropped out). Dropout as well as ensembles can be used as an approximation of Bayesian Neural Networks.

If the uncertainty per data point is not accurate enough one can determine whether the model is confident enough to make a decision based on a semantically meaningful collection of data points (such as images of cells from the same sample). In case of haematology the decision whether the sample should be flagged or not will be made if the model reports elevated uncertainty for enough cell on a slide.

We now consider how the uncertainty/confidence scores may be used to detect the presence of morphologically abnormal cells. The core concept of the present invention is the ability to use uncertainty or confidence scores to identify populations of morphologically abnormal cells even in the absence of training data covering morphologically abnormal cells. The output data comprises either a plurality of confidence scores or a plurality of uncertainty scores, which may be calculated using the processes explained in the previous few paragraphs. It has been observed that in specimen images depicting samples containing morphologically abnormal cells, there are an increased number or proportion of decreased confidence scores or increased uncertainty scores. This is because the analytical model has not been trained to generate output values based on such morphologically abnormal cells.

In some cases, the computer-implemented method may comprise detecting that one or more subsets of image data represent morphologically abnormal cells based on the respective uncertainty scores or confidence scores calculated for each of the one or more subsets of image data. For example, for a given subset of data, the computer-implemented method may comprise determining whether the uncertainty score generated in respect of that subset of image data exceeds a predetermined maximum uncertainty threshold. And, if it is determined that the uncertainty score exceeds the predetermined maximum uncertainty threshold, determining that the cell represented by the given subset of image data is morphologically abnormal. Similarly, for a given subset of data, the computer-implemented method may comprise determining whether the confidence score generated in respect of that subset of image data is less than a predetermined minimum confidence threshold. And, if it is determined that the uncertainty score is less than the predetermined minimum confidence threshold, determining that the cell represented by the given subset of image data is morphologically abnormal.

When a human or animal subject has a condition which leads to the presence of morphologically abnormal cells, it is likely that the specimen image will include a plurality of such cells. Thus, in addition to the detection of morphological abnormalities based on the confidence or uncertainty scores associated with individual cells, a statistical approach may also be employed in which the histogram of uncertainty scores or confidence scores is considered for the whole population of cells depicted in the specimen image. In these instances, the computer-implemented method may detect the presence of a subset of morphologically abnormal cells without necessarily identifying the specific cells displaying abnormalities.

Accordingly, determining whether an abnormality is likely present may comprise determining a proportion of the confidence scores in the output data which are less than a predetermined minimum confidence threshold; and determining whether one or more morphologically abnormal cells are likely to be present based on the proportion of confidence scores which are less than the predetermined minimum confidence threshold. The computer-implemented method may thus comprise: determining a proportion of the confidence scores in the output data which are less than a predetermined minimum confidence threshold; and determining whether one or more morphologically abnormal cells are likely to be present based on the proportion of confidence scores which are less than the predetermined minimum confidence threshold. Determining the proportion of confidence scores in the output data which are less than the predetermined confidence threshold may comprise determining, for each subset of data, whether the confidence score is less than or equal to the predetermined minimum confidence threshold; counting the number of subsets of data for which the confidence score is less than or equal to the predetermined minimum confidence threshold; and dividing the counted number by the total number of subsets of data. Determining whether one or more morphologically abnormal cells are likely to be present based on the proportion of confidence scores which are less than the predetermined minimum confidence threshold may comprise: determining whether the proportion of confidence scores exceeds a predetermined threshold proportion; and if it is determined that the proportion of confidence scores exceeds the predetermined threshold proportion, determining that the presence of morphologically abnormal cells in the specimen image is likely.

Similar processes may be carried out using uncertainty scores rather than confidence scores.

Specifically, determining whether an abnormality is likely present may comprise determining a proportion of the uncertainty scores in the output data which exceed a predetermined maximum uncertainty threshold; and determining whether one or more morphologically abnormal cells are likely to be present based on the proportion of uncertainty scores which exceed the predetermined maximum uncertainty threshold. The computer-implemented method may thus comprise: determining a proportion of the uncertainty scores in the output data which exceed a predetermined maximum uncertainty threshold; and determining whether one or more morphologically abnormal cells are likely to be present based on the proportion of uncertainty scores which exceed the predetermined maximum uncertainty threshold. Determining the proportion of uncertainty scores in the output data which exceed the predetermined maximum uncertainty threshold may comprise determining, for each subset of data, whether the confidence score exceeds the predetermined maximum uncertainty threshold; counting the number of subsets of data for which the uncertainty score exceeds the predetermined maximum uncertainty threshold; and dividing the counted number by the total number of subsets of data. Determining whether one or more morphologically abnormal cells are likely to be present based on the proportion of uncertainty scores which exceed the predetermined minimum confidence threshold may comprise: determining whether the proportion of uncertainty scores exceeds a predetermined threshold proportion; and if it is determined that the proportion of uncertainty scores exceeds the predetermined threshold proportion, determining that the presence of morphologically abnormal cells in the specimen image is likely.

In some cases, the output may comprise an indication of the subsets of data for which either the uncertainty score exceeds a predetermined maximum uncertainty threshold, or the confidence score is less than a predetermined minimum confidence threshold. Then, the computer-implemented method may further comprise instructions which when executed by display component of a computing device to display an annotated version of the specimen image. Preferably, the annotated version of the specimen image comprises indications (e.g. in the form of annotations, or superimpositions) of the cells for which the uncertainty score exceeds the predetermined maximum uncertainty threshold, or for which the confidence score is less than the predetermined minimum confidence threshold. In this way, the clinician is presented with an ergonomically improved display which highlights the cells which require further attention, ultimately reducing the amount of time which is required to analyse the specimen image.

A second aspect of the invention may provide a clinical support system comprising a processor, the processor configured to execute the computer-implemented method of the first aspect of the invention. The clinical support system may further comprise a display component. It will be appreciated that the optional features set out above in respect of the first aspect of the invention apply equally well to the second aspect of the invention, except where clearly incompatible or where context clearly dictates otherwise. The clinical support system may comprise a suitable module configured to execute each of the distinct operations of the computer-implemented method of the first aspect of the invention.

A third aspect of the invention may provide a computer program comprising instructions which, when executed by a processor of a computer, cause the processor to execute the computer-implemented method of the first aspect of the invention. It will be appreciated that the optional features set out above in respect of the first aspect of the invention apply equally well to the third aspect of the invention, except where clearly incompatible or where context clearly dictates otherwise. A fourth aspect of the invention may provide a computer-readable medium storing the computer program of the third aspect of the invention. It will be appreciated that the optional features set out above in respect of the first aspect of the invention apply equally well to the fourth aspect of the invention, except where clearly incompatible or where context clearly dictates otherwise.

A fifth aspect of the invention may provide a computer-implemented method of detecting the presence of morphologically abnormal cells in a specimen image, the computer-implemented method comprising: receiving electronic image data representative of a specimen image, the specimen image depicting a plurality of cells; applying an analytical model to each of a plurality of subsets of the image data, each subset corresponding to a respective portion of the specimen image which depicts a single cell, the analytical model configured to output, for each subset of the image data: a value parameterizing a property of the cell; and either a confidence score or an uncertainty score associated with the value, thereby generating output data comprising the plurality of confidence scores or plurality of uncertainty scores; either: determining a proportion of the confidence scores in the output data which are less than a predetermined minimum confidence threshold; or determining a proportion of the uncertainty scores in the output data which exceed a predetermined maximum uncertainty threshold; determining whether the proportion exceeds a predetermined threshold proportion; and generating an output indicative of the result of the determination, wherein if it is determined that the proportion exceeds the predetermined threshold proportion, the output comprises a flag. The flag preferably alerts a clinician to the possible presence of morphologically abnormal cells. It will be appreciated that the optional features set out above in respect of the first aspect of the invention apply equally well to the fifth aspect of the invention, except where clearly incompatible or where context clearly dictates otherwise.

A sixth aspect of the invention may provide a computer program comprising instructions which, when executed by a processor of a computer, cause the processor to execute the computer-implemented method of the fifth aspect of the invention. It will be appreciated that the optional features set out above in respect of the first aspect of the invention apply equally well to the sixth aspect of the invention, except where clearly incompatible or where context clearly dictates otherwise. A seventh aspect of the invention may provide a computer-readable medium storing the computer program of the sixth aspect of the invention. It will be appreciated that the optional features set out above in respect of the first aspect of the invention apply equally well to the seventh aspect of the invention, except where clearly incompatible or where context clearly dictates otherwise.

An eighth aspect of the invention may provide a clinical support system comprising a processor, the processor configured to execute the computer-implemented method of the fifth aspect of the invention. The clinical support system may further comprise a display component. It will be appreciated that the optional features set out above in respect of the first aspect of the invention and the fifth aspect of the invention apply equally well to the eighth aspect of the invention, except where clearly incompatible or where context clearly dictates otherwise. The clinical support system may comprise a suitable module configured to execute each of the distinct operations of the computer-implemented method of the fifth aspect of the invention.

The invention includes the combination of the aspects and preferred features described except where such a combination is clearly impermissible or expressly avoided.

### BRIEF DESCRIPTION OF THE DRAWINGS

Embodiments of the present invention will now be described with reference to the accompanying drawings, in which:

FIG. 1 shows a clinical support system which is configured to execute a computer-implemented method according to the present invention.

FIG. 2 is a flowchart illustrating an example of a computer-implemented method according to the present invention.

FIG. 3 is a histogram illustrating the uncertainty distribution in a normal population of cells.

FIGS. 4A and 4B are histograms illustrating the uncertainty distribution in populations of cells containing, respectively, immature granulocytes and abnormal blast cells.

### DETAILED DESCRIPTION OF THE DRAWINGS

Aspects and embodiments of the present invention will now be discussed with reference to the accompanying figures. Further aspects and embodiments will be apparent to those skilled in the art. All documents mentioned in this text are incorporated herein by reference.

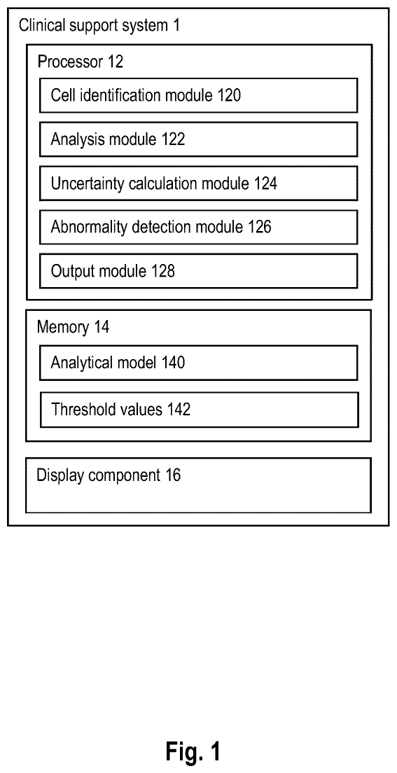

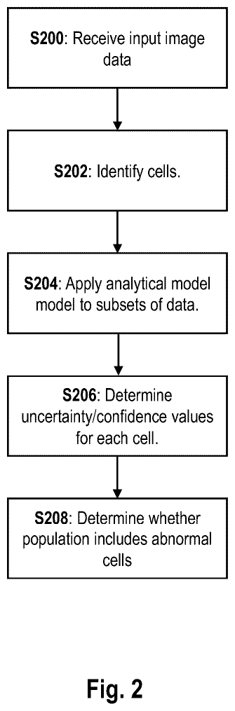

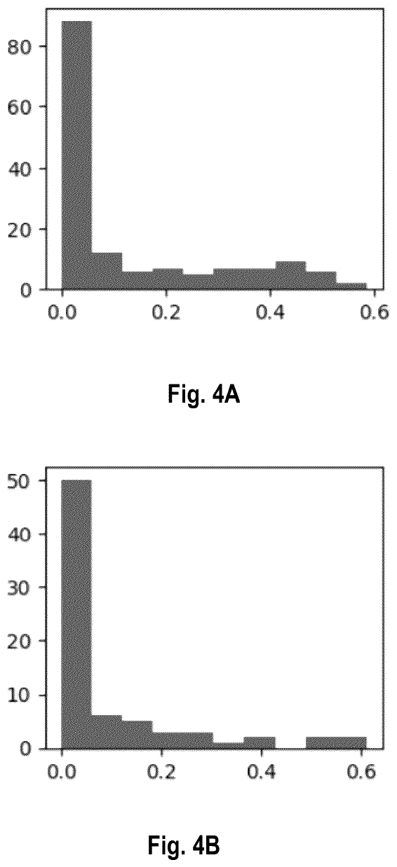

FIG. 1 is a schematic diagram of a clinical support system 1 according to e.g. the first aspect of the present invention. The clinical support system 1 comprises a processor 12, a memory 14, and a display component 16. In FIG. 1, these components are all shown to be part of the same system, but it will be appreciated that the system may be a distributed system in which the various components are located on different pieces of hardware, optionally in different locations. In those cases, the components (e.g. the processor 12, the memory 14, and the display component 16) may be connected via a network (not shown). The network may be a wired network such as a LAN, or WAN, or a wireless network such as a Wi-Fi network, the Internet, or a cellular network. We now discuss the structure of the clinical support system 1 before discussing, with reference to FIGS. 2 and 4, the operations which it is configured to execute. The processor 12 includes a plurality of modules. Herein, the term “module” is used to refer to a functional module which is configured or adapted to execute a particular function. The modules may be implemented in hardware (i.e. they may be separate physical components within a computer), in software (i.e. they may represent separate sections of code, which when executed by processor 12, cause it to perform a particular function), or in a combination of both.

Specifically, the processor 12 of FIG. 1 comprises: a cell identification module 120, an analysis module 122, an uncertainty determination module 124, an abnormality detection module 126, and an output module 128. The functions of each of these modules is described in more detail shortly. The memory 14 may be in the form of a permanent memory or a temporary memory, or may comprise a combination of the two. The memory 14 stores an analytical model 140, and a set of threshold values 142. The display component 16 is preferably in the form of a VPU, screen, or monitor which is configured to render data visually, to a clinician to view results.

FIG. 2 shows a process which is executed by the processor 12 of the clinical support system 1. In a first step S200, image data is received at the processor 12. The image data, more specifically, is electronic image data representative of a specimen image, the specimen image depicting a plurality of cells. The electronic image data, naturally, comprises a plurality of subsets of image data, each subset corresponding to a respective portion of the image data which depicts a single cell. In step S202, the cell identification module 120 is configured to identify the subsets of data corresponding to each individual cell. This may be done by applying an image analysis algorithm to the electronic image data received in step S200. The output of step S202 is a plurality of subsets of image data, each subset corresponding to a portion of the specimen image depicting a single cell.

Steps S204 and S206 are executed for every subset of image data output by step S202. However, for brevity we will only describe the process for a single subset of data. In step S204, the analytical model 140 is retrieved from memory 14 and applied to the subset of image data by the analysis module 122. For each subset of data, the output of step S204 is a value parameterizing a property of the cell represented by the subset of image data. For example, the analytical model 140 may be in the form of a classification model and the output of step S204 is a classification of the type of cell depicted. In step S206, the uncertainty determination module 124, for each subset of image data determines an uncertainty value associated with the output generated by the analysis module 122. Various methods may be employed to determine the uncertainty. It should be noted that in other implementations, a confidence score may be generated rather than an uncertainty score. The output of step S206 is an uncertainty score for each of the subsets of image data. Collectively, this may be referred to as output data.

In step S208, the abnormality detection module 126 of the processor 12 determines whether it is likely that there are morphologically abnormal cells present in the specimen image, based on the output data. There are various ways of doing so, but in one implementation, the proportion of cells for which the uncertainty score exceeds a predetermined maximum uncertainty threshold is determined. This proportion is then compared with a predetermined threshold proportion, and if it exceeds the predetermined threshold proportion, this is an indication that there are one or more morphologically abnormal cells in the specimen image. This is because high uncertainties are associated with unfamiliar cell types on which the analytical model has either not been trained, or has been poorly trained, due to a lack of training data (so-called “epistemic uncertainty”). Again, it will be appreciated that a similar procedure can be executed using confidence scores instead of uncertainty scores.

After a determination has been made by the uncertainty determination module 126 in step S208, an output is generated by the output module 128 in step S210. In some cases, the output may be transmitted to a database whereupon it may be accessed by a clinical computing network. Alternatively, the output may be a visual output, which may include a flag, as explained earlier in this application.

### Experimental Results

The inventors were able to test the invention using a classification model configured to identify white blood cells. A training set of 8 (normal) specimen slides was used, and a validation set of 4 specimen slides was used. Around 600 images were derived from each slide. For the abnormal examples, 10 specimen images including immature granulocytes were used, and 13 specimen images including blast cells. Tables explaining this are shown below

### Normal

| # Slides | Type |
|---|---|
| 8 | training set |
| 4 | validation set |

### Abnormal

| # Slides | Type |
|---|---|
| 10 | Immature Granulocytes (IG) |
| 13 | Blasts |

The abnormal slides were only used for validation.

An ensemble of 5 convolutional neural networks was trained on the normal specimen images to classify cells into the normal types: neutrophils, lymphocytes, monocytes, eosinophils, basophils and immature granulocytes. It reached an overall F1-score of 92% on the validation set (for 5 normal classes plus immature granulocytes). Because the number of normal slides is small, the validation set was also used for testing.

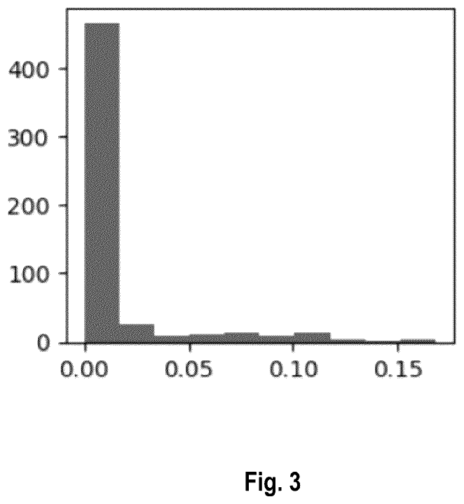

After training, the ensemble predictions of all the abnormal and the normal (validation set) slides were used as an uncertainty approximation. The histograms of the uncertainty distributions were used to tell normal samples apart from abnormal samples. The histograms are shown in FIGS. 3, 4A, and 4B.

FIG. 3 shows a normal sample. The x-axis represents the uncertainty value, and the y-axis represents the number of cells in the specimen image with the corresponding uncertainty levels. FIG. 4A shows a histogram representing the uncertainty distribution in a sample containing morphologically abnormal immature granulocytes, and FIG. 4B shows a histogram representing the uncertainty distribution in a sample containing morphologically abnormal blast cells. In each case, it should be noted that the scale on the x-axis is different from FIG. 3A. In FIG. 4A and FIG. 4B it is clear that the number of cells having higher uncertainty scores is markedly higher than for FIG. 3A, demonstrating that it is possible to detect samples of morphologically abnormal cells from a consideration of uncertainty or confidence scores.

### GENERAL STATEMENTS

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A computer-implemented method of detecting the presence of morphologically abnormal cells in a specimen image, the computer-implemented method comprising:
receiving electronic image data representative of a specimen image, the specimen image depicting a plurality of cells;
applying an analytical model to each of a plurality of subsets of the image data, each subset corresponding to a respective portion of the specimen image which depicts a single cell, the analytical model configured to output, for each subset of the image data: a value parameterizing a property of the cell; and either a confidence score or an uncertainty score associated with the value, thereby generating output data comprising the plurality of confidence scores or plurality of uncertainty scores; and
determining, based on the output data, whether one or more morphologically abnormal cells are likely to be present in the specimen image.

2. A computer-implemented method according to claim 1, wherein:
the analytical model is a classification model; and
the value parameterizing the property of the cell is a numerical or textual output indicative of the type of cell.

3. A computer-implemented method according to claim 2, wherein:
the classification model is a neural network model that has been trained to classify a cell as one of a plurality of cell types, based on data representing an electronic image of that cell, using training data comprising a plurality of images of normal or healthy cells, each image associated with a label indicative of the type of cell.

4. A computer-implemented method according to claim 3, wherein:
the classification model is configured to classify a cell as one of a plurality of types of white blood cell, the plurality of types of white blood cell including: neutrophils; lymphocytes;
monocytes; eosinophils; and basophils.

5. A computer-implemented method according to claim 2, wherein:
applying an analytical model to each of the plurality of subsets of image data comprises:
applying a plurality of analytical sub-models to each subset of the image data, each analytical sub-model of the plurality of analytical sub-models being configured to output, for each subset of image data, a respective plurality of values each parameterizing a property of the cell; and
determining, for each output plurality of values, a variance or standard deviation, the determined variance or standard deviation corresponding to the uncertainty score.

6. A computer-implemented method according to claim 5, wherein:
each of the plurality of analytical sub-models is trained on the same training data using a respective, different initial random seed to initialize the sub-model before training.

7. A computer-implemented method according to claim 2, wherein:
the uncertainty score is calculated using dropout.

8. A computer-implemented method according to claim 1, further comprising:
determining a proportion of the confidence scores in the output data which are less than a predetermined minimum confidence threshold; and
determining whether one or more morphologically abnormal cells are likely to be present based on the proportion of confidence scores which are less than the predetermined minimum confidence threshold.

9. A computer-implemented method according to claim 8, wherein:
determining whether one or more morphologically abnormal cells is likely present in the specimen image, based on the proportion of the confidence scores which fall below the predetermined confidence threshold comprises:
determining whether the proportion of confidence scores exceeds a predetermined threshold proportion; and
if it is determined that the proportion of confidence scores exceeds the predetermined threshold proportion, determining that the presence of morphologically abnormal cells in the specimen image is likely.

10. A computer-implemented method according to claim 1, further comprising:
determining a proportion of the uncertainty scores in the output data which exceed a predetermined maximum uncertainty threshold; and
determining whether one or more morphologically abnormal cells are likely to be present based on the proportion of uncertainty scores which exceed the predetermined maximum uncertainty threshold.

11. A computer-implemented method according to claim 10, wherein:
determining whether one or more morphologically abnormal cells is likely to be present in the specimen image, based on the proportion of the uncertainty scores which exceed the predetermined uncertainty threshold comprises:
determining whether the proportion of uncertainty scores exceeds a predetermined threshold proportion; and
if it is determined that the proportion of uncertainty scores exceeds the predetermined threshold proportion, determining that the presence of morphologically abnormal cells in the specimen image is likely.

12. A computer-implemented method according to claim 1, wherein:
if it determined that an abnormality is likely to be present in the specimen image, the computer-implemented method further comprises adding a flag to the electronic image data representative of the specimen image.

13. A computer-implemented method according to claim 1, wherein:
the specimen image is an image of a slide of a sample of a bodily fluid obtained from a human or animal subject.

14. A computer-implemented method according to claim 13, wherein:
the bodily fluid is blood.

15. A computer-implemented method of detecting the presence of morphologically abnormal cells in a specimen image, the computer-implemented method comprising:
receiving electronic image data representative of a specimen image, the specimen image depicting a plurality of cells;
applying an analytical model to each of a plurality of subsets of the image data, each subset corresponding to a respective portion of the specimen image which depicts a single cell, the analytical model configured to output, for each subset of the image data: a value parameterizing a property of the cell; and either a confidence score or an uncertainty score associated with the value, thereby generating output data comprising the plurality of confidence scores or plurality of uncertainty scores;
either:
determining a proportion of the confidence scores in the output data which are less than a predetermined minimum confidence threshold; or
determining a proportion of the uncertainty scores in the output data which exceed a predetermined maximum uncertainty threshold; determining whether the proportion exceeds a predetermined threshold proportion; and
generating an output indicative of the result of the determination, wherein if it is determined that the proportion exceeds the predetermined threshold proportion, the output comprises a flag.
